(19) United States
(12) Patent Application Publication
(10) Pub. No.: US 2010/0260929 A1
(43) Pub. Date: Oct. 14, 2010

(54) METHOD OF MAKING A COLOUR FILTER ARRAY

(76) Inventors: John R. Fyson, London (GB); Christopher L. Bower, Cambridgeshire (GB)

Correspondence Address: EASTMAN KODAK COMPANY;PATENT LEGAL STAFF, 343 STATE STREET, ROCHESTER, NY, 14650-2201, US

(21) Appl. No.: 12/677,901

(22) PCT Filed: Sep. 9, 2008
(86) PCT No.: PCT/GB2008/003049

§ 371 Date: Mar. 12, 2010

(30) Foreign Application Priority Data
Sep. 26, 2007 (GB) 0718841.0

(51) Int. Cl. B05D 5/06

(52) U.S. Cl. 427/162

(57) ABSTRACT

A method of making a colour filter array and atmospheric barrier comprises the steps of coating a layer of semi reflecting material onto a substrate, vapour depositing an essentially transparent layer to form a light interfering layer of one thickness on top of the semi reflecting layer and one or more stages, each comprising creating a patterned layer by printing on the light interfering layer, vapour depositing an essentially transparent layer over the whole patterned layer to provide a light interfering layer when combined with the first or previous light interfering layer and removing the patterned layer by a solvent. A second layer of semi reflecting material is then coated above the last light interfering layer.

### FIELD OF THE INVENTION

This invention relates to a method of making a colour filter array, especially by vapour deposition.

### BACKGROUND OF THE INVENTION

Colour filter arrays are found in displays and light sensors in the back of cameras. In displays the colour filter array, CFA, is placed in register in front of white light pixels to allow the viewing of colour. In sensors such as those used in cameras, the CFA is used in front of a panchromatic sensor to allow the detection of colour. The CFAs are usually an array of red, green and blue areas laid down in a pattern. A common array used in digital cameras is the Bayer pattern array. The resolution of each colour is reduced by as little as possible through the use of a 2×2 cell, and, of the three colours, green is the one chosen to be sensed twice in each cell as it is the one to which the eye is most sensitive.

Similar arrays can be used on displays. For example U.S. Pat. No. 4,877,697 describes arrays for liquid crystal displays (LCD) and US 2007/0123133 describes an array for an OLED device.

The arrays can be made in many ways, including ink jetting coloured inks, photographically, using photolithography, use of coloured inks etc. Another method is to create an interference filter, or Fabry-Perot cavity which has a cavity with dimensions chosen to reflect a particular colour of light. Behind the cavity is a reflector, which may be a smooth metal coating, or a Bragg reflector consisting of alternating layers of material with different refractive index. Such a filter will reflect different colours of light depending upon the angle of the incidence and observation. However, by careful choice of the relative thickness of the layers in the Bragg reflector, it is possible to reduce the amount that the colour changes as the viewing angle changes.

Some devices, such as OLEDs, are sensitive to air and must be sealed to keep out air and moisture. One way to do this is to coat the array with a thin inorganic metal oxide. This is described in CA 2133399.

Chemical vapour deposition (CVD) and atomic layer deposition (ALD) are, techniques for laying down thin layers of material, especially a metal oxide, onto a substrate.

Chemical vapour deposition is a chemical process used to produce high-purity, high-performance solid materials. The process is often used in the semiconductor industry to produce thin films of dielectrics and semiconductors. In a typical CVD process, the substrate is exposed to one or more volatile precursors, which react and/or decompose on the substrate surface to produce the desired deposit.

Atomic layer deposition is a self-limiting, sequential surface chemistry that deposits conformal thin films of materials onto substrates of varying compositions. ALD is similar in chemistry to CVD except that the ALD reaction breaks the CVD reaction into two or more partial reactions, keeping the precursor materials separate during the reaction sequence.

ALD can be used to deposit several types of thin films, including various ceramics, from conductors to insulators.

When making components it is usually necessary to pattern the material being laid down. There are a number of ways recorded for doing this:

Deposit an even layer of the material and, using a photolithographic method, etch the unwanted sections of the layer away using a suitable etch chosen so as not to damage the remainder of the device.

Put down a photoresist onto the substrate and image a profile in this resist using conventional lithography methods. Optionally treat this resist and then use CVD or ALD to coat a layer over the top. Scratch the top of the coating over the resist and treat with suitable solvent to remove the resist—the solvent percolating through the scratches. The coating falls off where the resist has been dissolved.

Applying a mask to the substrate, patterning the mask, using ALD or CVD to coat a layer over the patterned mask and then removing the mask mechanically (see WO2006/111766).

Using ALD and finding an inhibitor specific for the growing mechanism and printing this (see U.S. Pat. No. 7,030,001).

The first methods rely on the relatively complicated procedure of photolithography. This is a multi-step process usually consisting of the steps of spin-coating the resist, baking the resist, exposing the resist, baking the resist, developing the resist, washing and then drying it. In the third method the mask is patterned after being coated onto the substrate. This may be done using a photoresist method or perhaps more conveniently by ablating the mask with a suitably tuned laser.

### PROBLEM TO BE SOLVED BY THE INVENTION

There is a need to provide a patterned CFA layer that can also act as a barrier.

### SUMMARY OF THE INVENTION

According to the present invention there is provided a method of making a colour filter array and atmospheric barrier, comprising the steps of coating a layer of semi reflecting material onto a substrate, vapour depositing an essentially transparent layer to form a light interfering layer of one thickness on top of the semi reflecting layer and one or more stages, each comprising creating a patterned layer by printing on the light interfering layer, vapour depositing an essentially transparent layer over the whole patterned layer to provide a light interfering layer when combined with the first or previous light interfering layer, removing the patterned layer by a solvent; and coating a second layer of semi reflecting material above the last light interfering layer.

### ADVANTAGEOUS EFFECT OF THE INVENTION

The present invention provides a hard, waterproof, gas impermeable colour filter array. It removes the need to have at least two separate components, i.e. the colour filter array, the gas barrier and possibly a separate anti scratch layer. As a single device it is quicker to make and requires less assembly labour.

### BRIEF DESCRIPTION OF THE DRAWINGS

The invention will now be described with reference to the accompanying drawings in which:

FIG. 1 is a flow chart describing the steps of an atomic layer deposition process used in the present invention;

FIG. 2 is a cross sectional side view of an embodiment of a distribution manifold for atomic layer deposition that can be used in the present process;

FIG. 3 is a cross sectional side view of an embodiment of the distribution of gaseous materials to a substrate that is subject to thin film deposition;

FIGS. 4A and 4B are cross sectional views of an embodiment of the distribution of gaseous materials schematically showing the accompanying deposition operation;

FIGS. 5A and 5B illustrate the patterns used to create the colour filter array; and

FIG. 5C illustrates the final simple colour filter array.

### DETAILED DESCRIPTION OF THE INVENTION

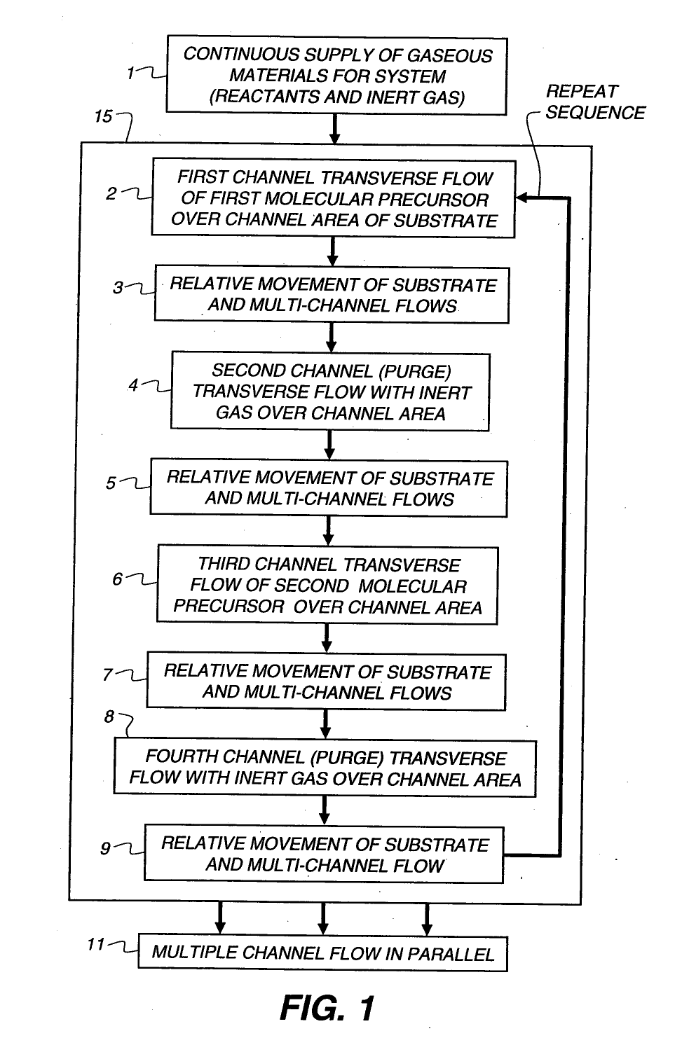

FIG. 1 is a generalized step diagram of a process for practicing the present invention. Two reactive gases are used, a first molecular precursor and a second molecular precursor. Gases are supplied from a gas source and can be delivered to the substrate, for example, via a distribution manifold. Metering and valving apparatus for providing gaseous materials to the distribution manifold can be used.

As shown in Step 1, a continuous supply of gaseous materials for the system is provided for depositing a thin film of material on a substrate. The Steps in Sequence 15 are sequentially applied. In Step 2, with respect to a given area of the substrate (referred to as the channel area), a first molecular precursor or reactive gaseous material is directed to flow in a first channel transversely over the channel area of the substrate and reacts therewith. In Step 3 relative movement of the substrate and the multi-channel flows in the system occurs, which sets the stage for Step 4, in which second channel (purge) flow with inert gas occurs over the given channel area. Then, in Step 5, relative movement of the substrate and the multi-channel flows sets the stage for Step 6, in which the given channel area is subjected to atomic layer deposition in which a second molecular precursor now transversely flows (substantially parallel to the surface of the substrate) over the given channel area of the substrate and reacts with the previous layer on the substrate to produce (theoretically) a monolayer of a desired material. Often in such processes, a first molecular precursor is a metal-containing compound in gas form (for example, a metallic compound such as titanium tetrachloride) and the material deposited is a metal-containing compound. In such an embodiment, the second molecular precursor can be, for example, a non-metallic oxidizing compound or hydrolyzing compound, e.g. water.

In Step 7, relative movement of the substrate and the multi-channel flows then sets the stage for Step 8 in which again an inert gas is used, this time to sweep excess second molecular precursor from the given channel area from the previous Step 6. In Step 9, relative movement of the substrate and the multi-channels occurs again, which sets the stage for a repeat sequence, back to Step 2. The cycle is repeated as many times as is necessary to establish a desired film or layer. The steps may be repeated with respect to a given channel area of the substrate, corresponding to the area covered by a flow channel. Meanwhile the various channels are being supplied with the necessary gaseous materials in Step 1. Simultaneous with the sequence of box 15 in FIG. 1, other adjacent channel areas are being processed simultaneously, which results in multiple channel flows in parallel, as indicated in overall Step 11.

The primary purpose of the second molecular precursor is to condition the substrate surface back toward reactivity with the first molecular precursor. The second molecular precursor also provides material as a molecular gas to combine with one or more metal compounds at the surface, forming compounds such as an oxide, nitride, sulfide, etc, with the freshly deposited metal-containing precursor.

The continuous ALD purge does not need to use a vacuum purge to remove a molecular precursor after applying it to the substrate.

Assuming that two reactant gases, AX and BY, are used, when the reaction gas AX flow is supplied and flowed over a given substrate area, atoms of the reaction gas AX are chemically adsorbed on a substrate, resulting in a layer of A and a surface of ligand X (associative chemisorptions) (Step 2). Then, the remaining reaction gas AX is purged with an inert gas (Step 4). Then, the flow of reaction gas BY, and a chemical reaction between AX (surface) and BY (gas) occurs, resulting in a molecular layer of AB on the substrate (dissociative chemisorptions) (Step 6). The remaining gas BY and by-products of the reaction are purged (Step 8). The thickness of the thin film can be increased by repeating the process cycle (steps 2-9).

Because the film can be deposited one monolayer at a time it tends to be conformal and have uniform thickness.

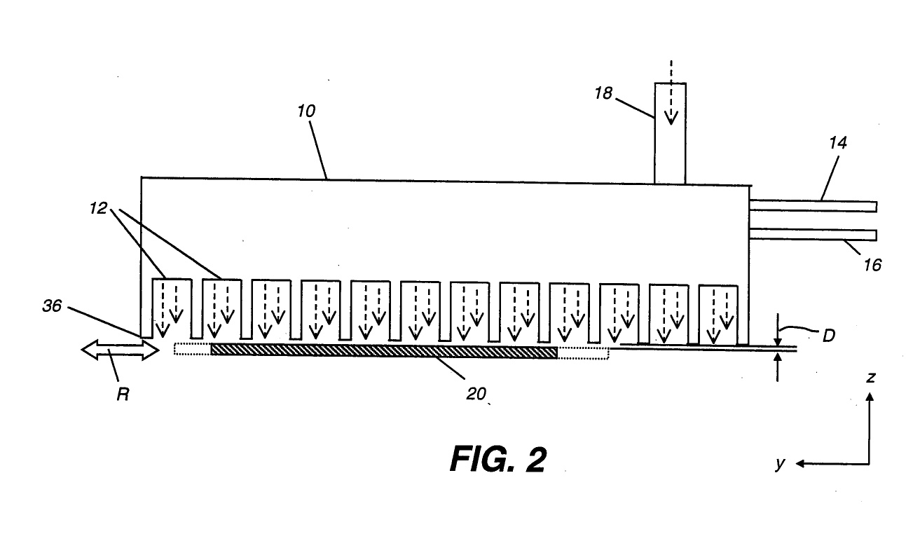

Referring now to FIG. 2, there is shown a cross-sectional side view of one embodiment of a distribution manifold 10 that can be used in the present process for atomic layer deposition onto a substrate 20. Distribution manifold 10 has a gas inlet port 14 for accepting a first gaseous material, a gas inlet port 16 for accepting a second gaseous material, and a gas inlet port 18 for accepting a third gaseous material. These gases are emitted at an output face 36 via output channels 12, having a structural arrangement described subsequently. The arrows in FIG. 2 refer to the diffusive transport of the gaseous material, and not the flow, received from an output channel. The flow is substantially directed out of the page of the figure.

Gas inlet ports 14 and 16 are adapted to accept first and second gases that react sequentially on the substrate surface to effect ALD deposition, and gas inlet port 18 receives a purge gas that is inert with respect to the first and second gases. Distribution manifold 10 is spaced a distance D from substrate 20, provided on a substrate support. Reciprocating motion can be provided between substrate 20 and distribution manifold 10, either by movement of substrate 20, by movement of distribution manifold 10, or by movement of both substrate 20 and distribution manifold 10. In the particular embodiment shown in FIG. 2, substrate 20 is moved across output face 36 in reciprocating fashion, as indicated by the arrow R and by phantom outlines to the right and left of substrate 20 in FIG. 2. It should be noted that reciprocating motion is not always required for thin-film deposition using distribution manifold 10. Other types of relative motion between substrate 20 and distribution manifold 10 could also be provided, such as movement of either substrate 20 or distribution manifold 10 in one or more directions.

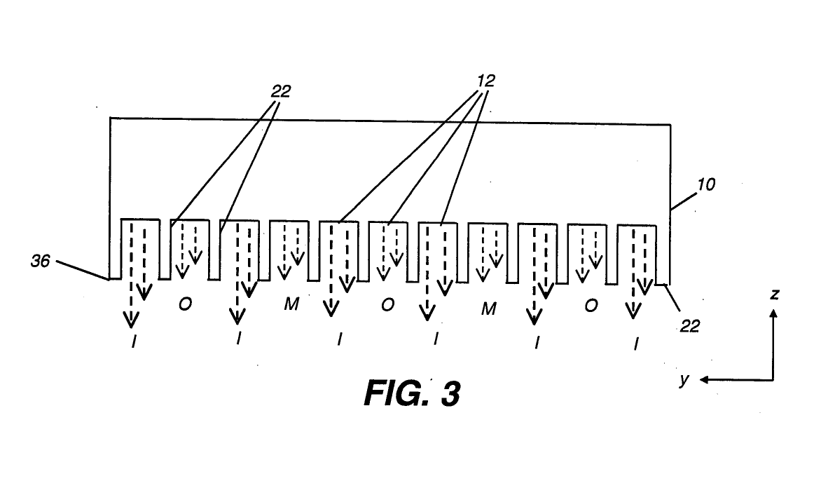

The cross-sectional view of FIG. 3 shows gas flows emitted over a portion of front face 36 of distribution manifold 10. In this particular arrangement, each output channel 12 is in gaseous flow communication with one of gas inlet ports 14, 16 or 18 seen in FIG. 2. Each output channel 12 delivers typically a first reactant gaseous material O, or a second reactant gaseous material M, or a third inert gaseous material I.

FIG. 3 shows a relatively basic or simple arrangement of gases. It is possible that a plurality of non-metal deposition precursors (like material O) or a plurality of metal-containing precursor materials (like material M) may be delivered sequentially at various ports in a thin-film single deposition. Alternately, a mixture of reactant gases, for example, a mixture of metal precursor materials or a mixture of metal and non-metal precursors may be applied at a single output channel when making complex thin film materials, for example, having alternate layers of metals or having lesser amounts of dopants admixed in a metal oxide material. The critical requirement is that an inert stream labeled I should separate any reactant channels in which the gases are likely to react with each other. First and second reactant gaseous materials O and M react with each other to effect ALD deposition, but neither reactant gaseous material O nor M reacts with inert gaseous material I.

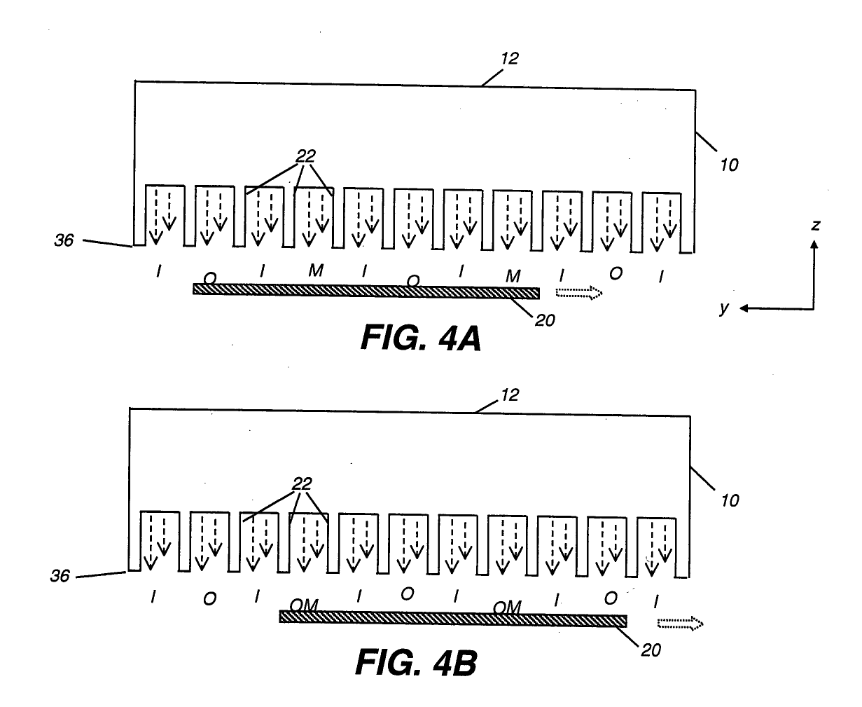

The cross-sectional views of FIGS. 4A and 4B show, in simplified schematic form, the ALD coating operation performed as substrate 20 passes along output face 36 of distribution manifold 10 when delivering reactant gaseous materials O and M. In FIG. 4A, the surface of substrate 20 first receives an oxidizing material from output channels 12 designated as delivering first reactant gaseous material O. The surface of the substrate now contains a partially reacted form of material O, which is susceptible to reaction with material M. Then, as substrate 20 passes into the path of the metal compound of second reactant gaseous material M, the reaction with M takes place, forming a metallic oxide or some other thin film material that can be formed from two reactant gaseous materials.

As FIGS. 4A and 4B show, inert gaseous material I is provided in every alternate output channel 12, between the flows of first and second reactant gaseous materials O and M. Sequential output channels 12 are adjacent, that is, share a common boundary, formed by partitions 22 in the embodiments shown. Here, output channels 12 are defined and separated from each other by partitions 22 that extend perpendicular to the surface of substrate 20.

Notably; there are no vacuum channels interspersed between the output channels 12, that is, no vacuum channels on either side of a channel delivering gaseous materials to draw the gaseous materials around the partitions. This advantageous, compact arrangement is possible because of the innovative gas flow that is used. Unlike gas delivery arrays of earlier processes that apply substantially vertical (that is, perpendicular) gas flows against the substrate and should then draw off spent gases in the opposite vertical direction, distribution manifold 10 directs a gas flow (preferably substantially laminar in one embodiment) along the surface for each reactant and inert gas and handles spent gases and reaction by-products in a different manner. The gas flow used in the present invention is directed along and generally parallel to the plane of the substrate surface. In other words, the flow of gases is substantially transverse to the plane of a substrate rather than perpendicular to the substrate being treated.

The above described method and apparatus are one example of a vapour deposition process that can by used in the present invention. The invention works equally well using chemical vapour depositions.

### EXAMPLES

In all the examples ALD/CVD coating was carried out using apparatus similar to that described above. Either titanium dioxide or alumina was coated. For titanium dioxide, titanium tetrachloride was in one bubbler and water in the other. For alumina, a 1M solution of trimethylaluminium in heptane was in one bubbler and water in the other.

For both oxides, the flow rate of the carrier gas through the bubblers was 50 ml/min. The flow rate of diluting carrier gas was 300 ml/min for the water reactant and 150 ml/min for the titanium tetrachloride. The flow rate of the inert separator gas was 21/min. Nitrogen was used for the carrier gas in all instances. A calibration was run to determine the thickness versus number of substrate oscillations for both oxides.

### Example 1

A simple colour filter array was created by a combination of ALD and inkjet printed P604A, by printing squares of the fluoropolymer to act as a resist for the ALD layers. A 62×62×1 mm glass slide was first coated with a thin layer of aluminium by vacuum evaporation, next a layer of titania approximately 200 nm thick was deposited by ALD.

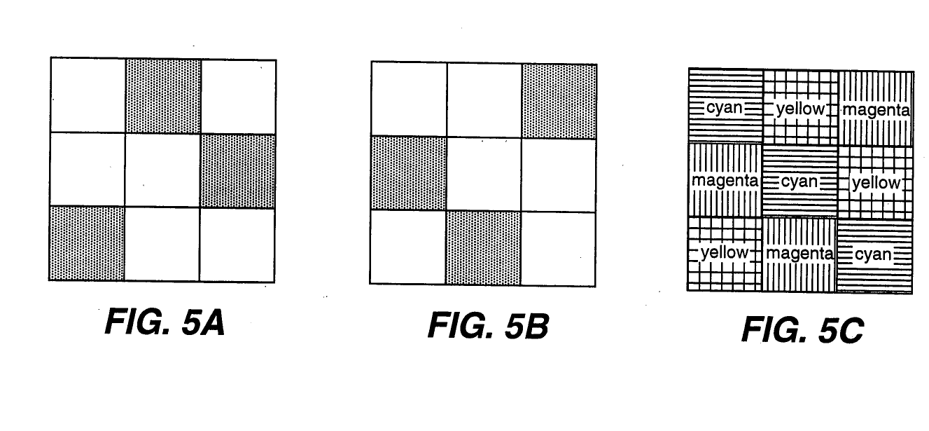

A mixture of 25% w/w Fluoropel P604A+75% perfluorodecalin was made up and loaded into a Dimatix ink-jet printer as described in the instruction book. A line of three 5 mm squares of P604A was printed using the Dimatix printer filled with ink, as shown in FIG. 5a. The sample was next coated with a layer of titania approximately 50 nm thick before printing another three 5 mm squares of fluoropolymer to complete the 3×3 matrix, as shown in FIG. 5b. After laying down a final layer of titania approximately 50 nm thick the fluoropolymer was removed using HFE 7500 solvent and gentle rubbing with a nitrile gloved hand. Over this was coated a thin layer of aluminium by vacuum evaporation. The resulting three colour CFA is shown in diagrammatic form in FIG. 5c.

### Example 2

Example 1 was repeated using PVP as the masking material.

A simple colour filter array was created. A 62×62×1 mm glass slide was first coated with a thin layer of aluminium by vacuum evaporation, next a layer of titania approximately 200 nm thick was deposited by ALD.

A PVP ink-jet ink was made up consisting a 10% K30 10% ethylene glycol and 1% Triton X-100. The latter two components were added to aid jetting. A line of three 5 mm squares of the PVP ink was printed using the Dimatix printer filled with ink as shown in FIG. 5a. The sample was next coated with layer of titania approximately 50 nm thick before printing another three 5 mm squares of the PVP ink to complete the 3×3 matrix as shown in FIG. 5b. After a final layer of titania approximately 50 nm thick the PVP ink was removed by dipping in warm deionised water and gentle rubbing with a nitrile gloved hand.

Over this was coated a thin layer of aluminium by vacuum evaporation. The result was very similar to that in Example 1i.e. a three colour CFA as shown in diagrammatic form in FIG. 5c.

### Example 3

A complex colour filter array was created.

A 62×62×1 mm glass slide was first coated with a “Bragg reflector” of 5 layers of alternating alumina and titanium dioxide layers, each approximately 100 nm thick, starting and finishing with low refractive index alumina. On to this a layer of titania approximately 200 nm thick was deposited.

A mixture of 25% w/w Fluoropel P604A+75% perfluorodecalin was made up and loaded into a Dimatix ink-jet printer as described in the instruction book. A line of three 5 mm squares of P604A was printed using the Dimatix printer filled with ink, as shown in FIG. 5a. The sample was next coated with layer of titania approximately 50 nm thick before printing another three 5 mm squares of fluoropolymer to complete the 3×3 matrix as shown in FIG. 5b. After a final layer of titania approximately 50 nm thick the fluoropolymer was removed using HFE 7500 solvent and gentle rubbing with a nitrile gloved hand.

Over this was coated another “Bragg reflector” of 5 layers, alternating alumina and titanium dioxide layer, each approximately 100 nm thick, starting and finishing with low refractive index alumina.

The result was a three colour CFA as shown in diagrammatic form in FIG. 5c similar to those made in Examples 1 and 2.

Examples 1 and 2 used aluminium as the semi reflecting layer. It will be understood that the invention is not limited to the use of aluminium. Any other suitable highly reflective metal, such as chromium or silver, could be used.

The invention has been described in detail with reference to preferred embodiments thereof. It will be understood by those skilled in the art that variations and modifications can be effected within the scope of the invention.

1. A method of making a colour filter array and atmospheric barrier, comprising the steps of coating a layer of semi reflecting material onto a substrate, vapour depositing an essentially transparent layer to form a light interfering layer of one thickness on top of the semi reflecting layer and one or more stages, each comprising creating a patterned layer by printing on the light interfering layer, vapour depositing an essentially transparent layer over the whole patterned layer to provide a light interfering layer when combined with the first or previous light interfering layer, removing the patterned layer by a solvent; and coating a second layer of semi reflecting material above the last light interfering layer.

2. A method as claimed in claim 1 wherein the patterned layer is removed at each stage.

3. A method as claimed in claim 1 wherein the patterned layers are removed after the final stage.

4. A method as claimed in claim 1 wherein the semi reflecting layer comprises a thin coating of metal.

5. A method as claimed in claim 4 wherein the metal used is aluminium.

6. A method as claimed in claim 1 wherein the semi reflecting layer comprises a multilayered Bragg reflector having a number of layers of alternate metal oxides with high and low refractive indices.

7. A method as in claim 1, 2 or 3 wherein the semi reflecting layer comprises a multilayered Bragg reflector having a number of layers of alternate metal oxides with high and low refractive indices in which the ratio of the layer thickness is optimised to decrease the change in colour with changing observation angle.
